(19) United States
(12) Patent Application Publication
(10) Pub. No.: US 2010/0260900 A1
(43) Pub. Date: Oct. 14, 2010

(54) Microwaveable product

(75) Inventors: Anthony David DeVerney, Naperville, IL (US); Jeffrey Anthony Czarny, Schaumburg, IL (US)

Correspondence Address: FOLEY & LARDNER LLP, 777 EAST WISCONSIN AVENUE, MILWAUKEE, WI, 53202-5306, US

(73) Assignee: Sara Lee Corporation

(21) Appl. No.: 12/661,334

(22) Filed: Mar. 15, 2010

Related U.S. Application Data
(60) Provisional application No. 61/160,970, filed on Mar. 17, 2009.

(51) Int. Cl. B65D 81/34; A23L 1/01; H05B 6/80

(52) U.S. Cl. 426/107; 426/234; 219/730; 219/734

(57) ABSTRACT

A microwaveable product includes a container having a base and at least one sidewall extending from the base, the base and the at least one sidewall defining an interior; a core extending from the base within the interior, the core and the container defining a first compartment and a second compartment; and a lid having a moveable portion that is moveable to selectively engage the core and to separately seal the first compartment from the second compartment.

### CROSS-REFERENCE TO RELATED PATENT APPLICATIONS

This application claims the benefit of priority of U.S. Provisional Application No. 61/160,970, filed Mar. 17, 2009, which is incorporated by reference herein in its entirety. This application is related to U.S. application Ser. No. 12/364,443, filed Feb. 2, 2009, which is incorporated by reference herein in its entirety.

### BACKGROUND

The present disclosure relates generally to the field of microwaveable products, and more specifically, to microwaveable products including microwaveable food products and packages that permit fully baking a raw and/or frozen microwaveable food product.

Microwaveable food products and packages for microwaveable food products are generally known. However, there are many challenges associated with microwaving food products, particularly when the food products are microwaveably baked from a raw and/or fully frozen state. Conventional packages that utilize susceptors often do not provide appropriate contact between the susceptor material and the surface of the food product, resulting in reduced heat transfer between the susceptor and the food product. Furthermore, many microwaveable products that utilize susceptors are not properly vented, resulting in unwanted moisture being reabsorbed into the food product.

Accordingly, it would be advantageous to provide an improved microwaveable product or package having a susceptor that maintains intimate contact with a food product and provides improved ventilation of moisture produced by the food product.

### SUMMARY

One embodiment relates to a microwaveable product comprising a container having a base and at least one sidewall extending from the base, the base and the at least one sidewall defining an interior; a core extending from the base within the interior, the core and the container defining a first compartment and a second compartment; and a lid having a moveable portion that is moveable to selectively engage the core and to separately seal the first compartment from the second compartment.

Another embodiment relates to a method of using a microwaveable product comprising providing a microwaveable product having a container, a core disposed within the container, a first cover, and a second cover disposed between the first cover and the container, wherein the container and the core define first and second compartments; removing the first cover; removing the second cover; and coupling the first cover to the container and the core and depressing a portion of the first cover to seal the first and second compartments.

Another embodiment relates to a microwaveable product comprising a container having a base and at least one sidewall extending from the base, the base and the at least one sidewall defining an interior, at least a portion of the at least one sidewall including a susceptor material; a core extending from the base within the interior, at least a portion of the core including a susceptor material; a cover configured to be coupled to the container; and a flexible seal provided between the cover and the core and removeably sealed to the container.

### BRIEF DESCRIPTION OF THE DRAWINGS

FIG. 1 is an exploded perspective view of a microwaveable product according to an exemplary embodiment.

FIG. 2 is a cross-sectional view of the microwaveable product of FIG. 1 according to an exemplary embodiment.

FIG. 3 is a cross-sectional perspective view of a portion of the microwaveable product of FIG. 1 according to an exemplary embodiment.

FIG. 4 is an exploded perspective view of a microwaveable product according to an exemplary embodiment.

FIG. 5 is an exploded side view of a microwaveable product according to an exemplary embodiment.

FIG. 6 is an exploded perspective view of a microwaveable product according to an exemplary embodiment.

FIG. 7 is a cross-sectional view of a microwaveable product according to another exemplary embodiment.

FIG. 8 is a cross-sectional view of the product of FIG. 7 according to an exemplary embodiment.

FIG. 9 illustrates various cover configurations according to various exemplary embodiments.

FIG. 10 is an exploded cross-sectional view of a microwaveable product according to an exemplary embodiment.

FIGS. 11-12 illustrate a process of preparing a food product according to an exemplary embodiment.

FIG. 13 is an exploded perspective view of a microwaveable product according to an exemplary embodiment.

FIG. 14 is a cross-sectional view of the microwaveable product of FIG. 13 according to an exemplary embodiment.

### DETAILED DESCRIPTION OF EXEMPLARY EMBODIMENTS

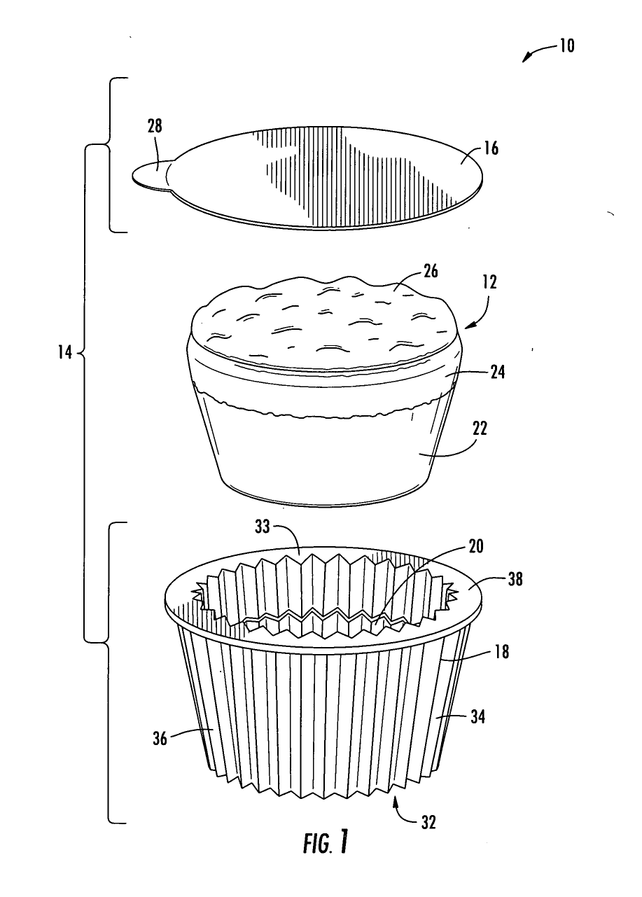

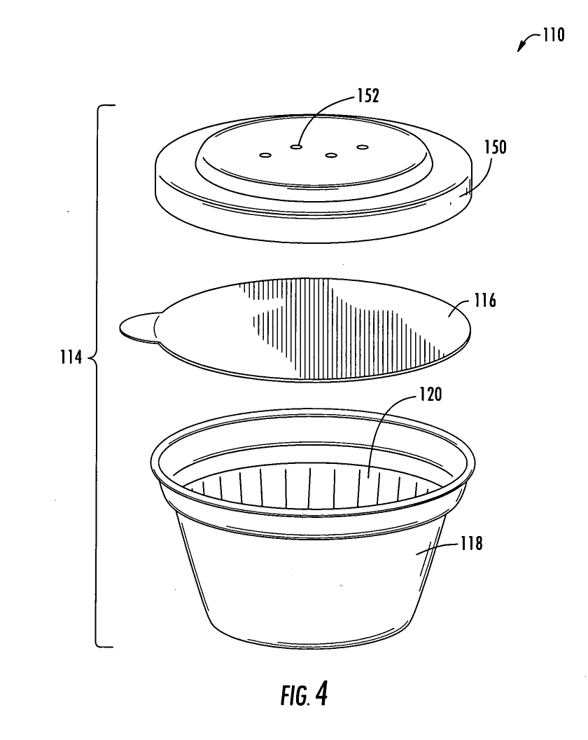

Referring to FIGS. 1-3, a microwaveable product 10 is shown according to an exemplary embodiment and includes a food product 12 (e.g., a microwaveable food product, such as a breakfast, lunch, or dinner meal, etc.) and a package 14 (e.g., a freezable, refrigeratable, and/or microwaveable package, etc.). Package 14 includes a cover 16 (e.g., a lid, top, sealing member, etc.), a container 18 (e.g., a cup, bowl, tray, etc.), and a susceptor 20 (e.g., a microwave-interactive layer, film, or laminate, etc.). According to an exemplary embodiment, microwaveable product 10 may be provided to consumers as a frozen product (e.g., such that food product 12 is provided in frozen form). According to various alternative embodiments, product 10 may be provided to consumers as a refrigerated product or a non-refrigerated, non-frozen product (e.g., at room temperature).

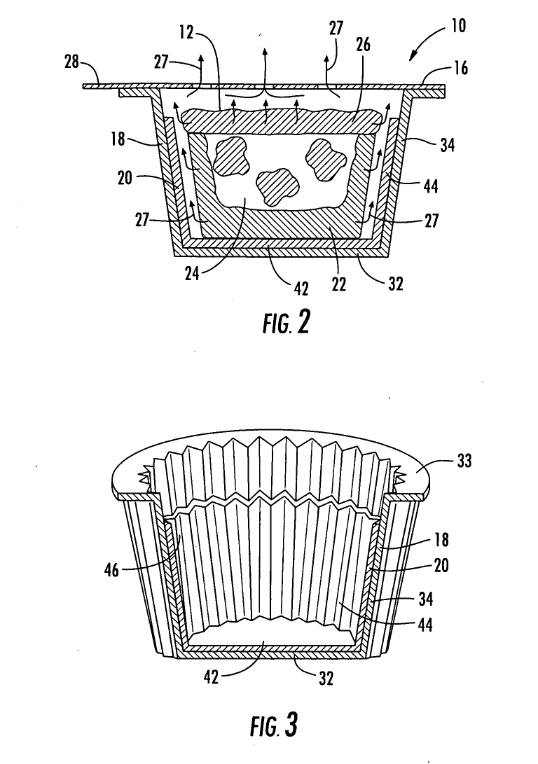

According to an exemplary embodiment, as shown in FIG. 2, food product 12 may include one or more of a first or raw dough component 22 (e.g., a breakfast dough, raw dough, etc.), a second component 24 (e.g., eggs, meat, cheese, protein sources, a combination thereof, a frozen, fully-cooked component, etc.), and a third component 26 (e.g., cheese, cheese sauce, gravy, a cooked/uncooked, fully frozen component, etc.). According to one embodiment, food product 12 may weigh approximately five ounces when fully baked. According to various alternative embodiments, food product 12 may weigh more or less than five ounces when fully baked. The components of food product 12 may be selected based in part on moisture/fat content and expected steam/moisture release due to microwave baking. While food product 12 is generally referred to herein as a breakfast meal, other types of food products may be used, including various types of snacks, lunches, dinners, and so on (e.g., portable breakfasts, multi-component breakfasts or meals, a quiche, etc.). Furthermore, while food product 12 may be referred to as a frozen food product, alternatively, food product 12 may be a refrigerated or non-refrigerated food product. For example, food product 12 may include a dry mix or powder such as dried fruits, grains, yoghurt chips, etc., as discussed in further detail with respect to FIGS. 7-14.

Raw dough component 22 may be, for example, a non-proof “Danish biscuit” formula that provides a fresh-baked appeal and flavor. The make-up of raw dough component 22 may be based upon the moisture and/or fat contents of the dough and the release of moisture from the dough. Other components of food product 12 may include eggs, meat, cheese, sauces, gravies, etc. to provide a unique finished product and optimized performance of the microwaveable product. Furthermore, various types of “flavored”/“unflavored” doughs may be used as part of food product 12.

As shown in FIGS. 1-3, according to an exemplary embodiment, cover 16 may be a flexible cover that may be made from a foil film or fiber/paper material, and sealed to container 18. Cover 16 may be removably coupled to container 18 to enclose food product 12 and susceptor 20 within container 18. Cover 16 may be coupled to container 18 in a variety of ways, including heat sealing, adhesives, sonic welding, induction sealing, etc. Cover 16 may be a self-venting cover having a low-barrier construction such that steam and moisture may pass through cover 16 (e.g., through perforations, holes, etc.). According to an exemplary embodiment, cover 16 may include one or more temperature-sensitive vent portions that are configured to open or dilate upon the temperature and/or pressure within container 18 reaching a predetermined level such that steam generated within container 18 is permitted to escape. Other ways of providing venting through cover 16 may be used according to various alternative embodiments, including perforations, apertures, etc. For example, cover 16 may be provided with a “tear-away” portion that a user may remove (e.g., tear off, peel away, etc.) prior to baking to ensure proper venting. According to an exemplary embodiment, between ten and fifteen percent of the surface area of cover 16 is vented in order to provide proper moisture exhaust during baking of food product 12.

According to one embodiment, cover 16 includes one or more tabs 28 (e.g., pull-tabs, extended portions, etc.) that extend beyond container 18 such that a user may easily grasp tab 28 and remove cover 16 from container 18 (e.g., an “easy-peel” type configuration). Other ways for permitting a user to remove cover 16 may be used according to various alternative embodiments. Cover 16 may also have one or more portions having graphics, text, etc., intended to provide consumers with various types of information, including ingredient information, nutritional information, preparation instructions, and so on. Other types of information may be provided on cover 16 according to various other embodiments.

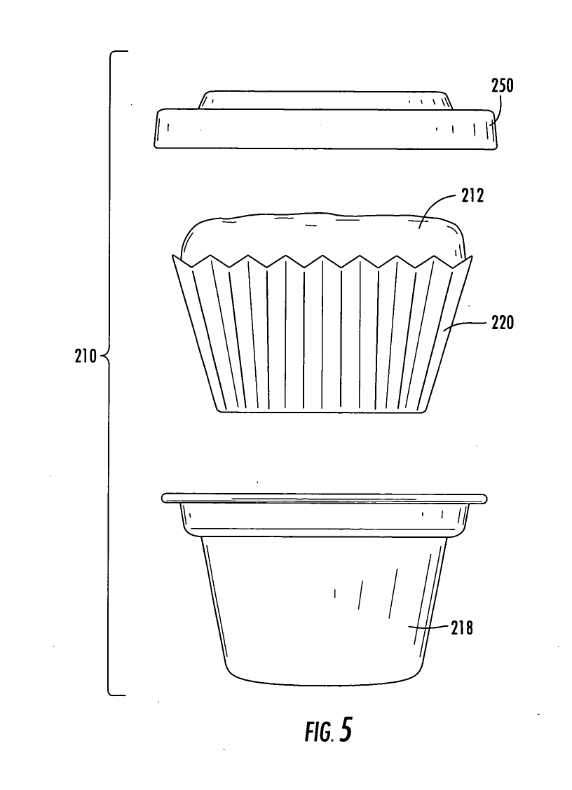

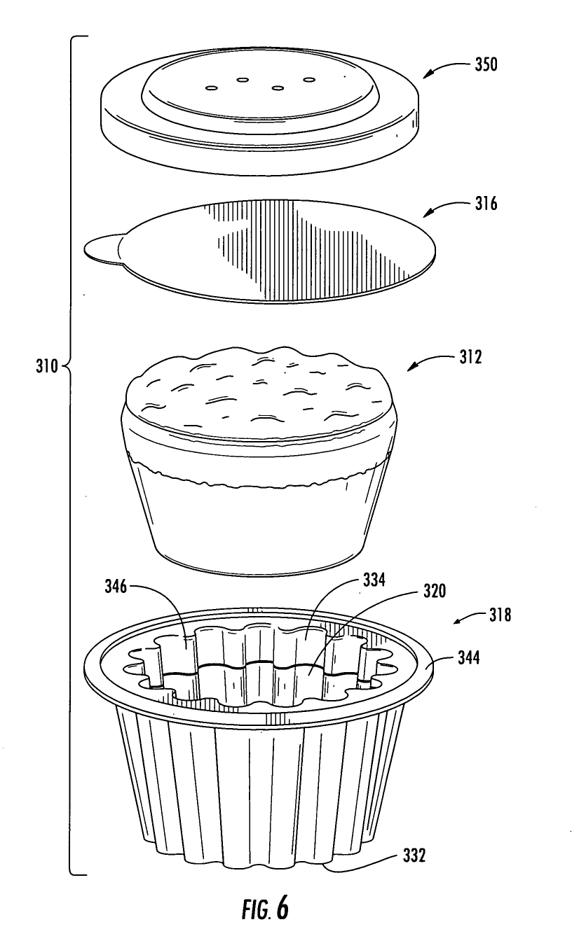

While cover 16 is shown in FIGS. 1-3 as a flexible cover, according to various other exemplary embodiments, cover 16 may be provided in other forms. For example, rather than a flexible foil/film or fiber-paper cover, cover 16 may be a rigid or semi-rigid polymer (e.g., polypropylene, etc.), such as cover 150 shown in FIG. 4. According to an exemplary embodiment, cover 16 may be provided with a susceptor (e.g., on an inner surface) to provide browning/crisping to one or more portions of the top of food product 12 (e.g., a pot-pie, etc.). Furthermore, cover 150 and cover 16 may be used in combination with each other, such that both a flexible cover component and a rigid cover component are provided (as also discussed with respect to FIG. 6). Furthermore, cover 16 may be provided as a tamper-resistant cover intended to prevent tampering with food product 12 within container 18. Further yet, cover 16 and/or cover 150 may be provided with a laminate layer (e.g., a clear-coat polymer layer) provided on the inner surface of the cover to provide a surface texture intended to inhibit the formation of beads due to moisture accumulation and facilitate the venting of moisture through cover 16 and/or cover 150. Further, cover 16 and/or cover 150 may be omitted entirely and/or during the microwaving of food product 12.

Referring further to FIGS. 1-2, according to one embodiment, susceptor 20 is a thin-gauge susceptor and includes a bottom 42 and a sidewall 44 that extends from bottom 42. Sidewall 44 extends from bottom 42 at an incline (e.g., a slope, draft, or other non-perpendicular surface) such that the diameter of susceptor 20 increases from bottom to top (e.g., in a shape similar to a conventional muffin tin liner or baking cup). This configuration facilitates insertion and removal of food product 12 from susceptor 20 and minimizes the amount of food product 12 that may stick or otherwise be retained by susceptor 20 and/or container 18 after baking. Susceptor 20 facilitates the browning or crisping of food product 12 in order to provide a desirable texture to the exterior of food product 12 by absorbing a portion of the microwave energy that would otherwise pass through to food product 12. The absorbed microwave energy is converted into heat by susceptor 20 and transferred to the surface of food product 12. In some embodiments, susceptor 20 may be a laminate made up of a metal or microwave-interactive layer and one or more protective and/or structural layers. Alternatively, susceptor 20 may be an ink-type sensor.

As shown in FIGS. 1-3, according to an exemplary embodiment, sidewall 44 of susceptor 20 may have a fluted or corrugated construction such as a fluted formed paper construction or a corrugated formed paper construction (e.g., pleated, zig-zagged, scalloped, accordion-like, wavy-shaped, round-edged, pointed-edged, etc.). According to one embodiment, the corrugated construction includes a number of corrugations, or flutes, 46 that are generally flat, or linear members, and are folded or otherwise angled relative to one another to provide the corrugated construction of susceptor 20. According to one embodiment, corrugations 46 may each have a width or depth (e.g., as measured, in a radial direction extending from the center of container 18) of approximately one-eighth inch. According to various alternative embodiments, the width of corrugations 46 may be increased or decreased (e.g., more or less than one-eighth inch). In some embodiments, corrugations 46 may be of equal sizes and be equally distributed about the circumference of susceptor 20 (e.g., to provide different “pitches” or different numbers of corrugations or flutes per inch). According to other embodiments, corrugations 46 may be different sized and/or be unequally spaced about the circumference of susceptor 20. According to yet other embodiments, corrugations 46 may be provided as non-linear members such as wave-formed members, scallops, etc.

As shown in FIGS. 1-3, container 18 includes a bottom 32 and a sidewall 34. Sidewall 34 may include corrugations 36 that extend about one or both of the inside and outside surfaces of sidewall 34. For example, according to one embodiment, sidewall 34 include corrugations 36 on both the inside and the outside surfaces. Alternatively, corrugations 36 may be provided on only the inside surface of sidewall 34, and sidewall 34 may have a substantially smooth or otherwise-shaped outer surface. Similar to corrugations 46 on susceptor 20, corrugations 46 may be provided in a wide variety of shapes, sizes, and configurations in order to be adapted to a variety of applications. Sidewall 34 of container 18 may extend from bottom 32 to an upper surface, or ledge 33 (e.g., a lip/flange, etc.), which may be a heat-sealable surface intended to provide a mating surface for cover 16. Container 18 may have a high-barrier construction such that container 18 does not permit the release of steam, moisture, etc. from container 18 that may be generated by food product 12.

As shown in FIG. 2, the diameter of container 18 increases from bottom to top, such that sidewall 34 has a sloped configuration relative to bottom 32. This sloped configuration may facilitate venting of food product 12 by permitting moisture escaping from the sides of food product 12 to be “wicked” along sidewall 34 (e.g., along a path shown by arrows 27 in FIG. 2) and toward cover 16, where it may then escape. According to one embodiment, sidewall 34 may have a slope of approximately 6 degrees offset from vertical, although the slope may vary according to various alternative embodiments, such that the slope may be between 5 degrees and 45 degrees, between 6 degrees and 10 degrees, etc. It should be noted that FIG. 2 is shown schematically to illustrate certain features of the embodiment shown therein, and actual sizes and dimensions shown in FIG. 2 are not to scale and the actual components may have differing configurations than those illustrated in FIG. 2.

According to an exemplary embodiment, susceptor 20 is provided as an integral part of container 18 (e.g., such that the susceptor is form-molded, cast or otherwise formed together with the container). For example, susceptor 20 may be provided as a metallic layer that is applied to or otherwise formed or laminated with container 18, such that susceptor 20 includes a layer of metallic material having a corrugated structure substantially similar to that of container 18. Further, as discussed with respect to FIG. 6, container 18 may be formed (e.g., thermoformed) from a generally flat paper material after a generally flat susceptor material is bonded to the paper material. Ledge 33 may be provided as an injection-molded feature (e.g., a polymer component) that is bonded to sidewall 34 of container 18.

According to various alternative embodiments, susceptor 20 may be provided as a separate component from container 18. For example, susceptor 20 may simply be inserted into the interior of container 18, or susceptor 20 may be married or bonded (e.g., chemically, mechanically, via adhesives, a combination thereof, etc.) to container 18. Providing susceptor 20 as a separate component from container 18 may improve moisture exhaust away from the surface of food product 12 by allowing moisture generated by food product 12 to travel upward along susceptor 20 and then travel back downward into the space between susceptor 20 and container 18. Alternatively, susceptor 20 may be a vented susceptor that permits moisture to escape directly through the susceptor material (e.g., through holes, apertures, perforations, slits, etc.). According to any of these embodiments, susceptor 20 and/or container 18 may be provided with an additional release layer intended to facilitate the removal and/or consumption of food product 12 from container 18 and susceptor 20 after baking.

According to an exemplary embodiment, susceptor 20 (whether separate from or integral to container 18) does not extend to the full height of container 18. For example, as shown in FIG. 2, sidewall 44 of susceptor 20 extends approximately eighty percent of the distance from the bottom to the top of sidewall 34 of container 18. For example, if container 18 has a height of 2 inches, susceptor 20 may extend to a height of between 1.7 and 1.9 inches (e.g., approximately 1.8 inches). According to various other embodiments, sidewall 44 of susceptor 20 may extend a greater or lesser distance along sidewall 34 of container 18 (e.g., between 40 percent and 90 percent, between 60 and 85 percent, etc.). Providing susceptor 20 having a relatively shorter height than container 18 permits a portion of food product 12 to extend above susceptor 20, thereby permitting heating (e.g., cooking, baking, etc.) of the top of food product 12 by absorption of the microwaves (rather than conduction or radiation heating by susceptor 20), and avoiding overbaking. In some embodiments, the height of susceptor 20 is based on the make-up of the particular food product used (e.g., fat/moisture content, viscosity, etc.), and may be varied accordingly.

In order to ensure consumer safety, microwaveable product 10 may further be provided with a tamper-resistant feature intended to provide evidence of tampering with product 10. For example, should a flexible cover such as cover 16 be utilized, it may be heat sealed to container 18 such that any tampering with cover 16 would be evident to a consumer. Alternatively, the entirety of product 10 may be shrink-wrapped or otherwise secured within a plastic or other type of material such that tampering would be evident to consumers. Further, one or more components of microwaveable product 10 may include functional barrier properties or features that are intended to maintain a proper environment (e.g., ambient, refrigerated, frozen, etc.) for food products. The barrier features may be customized based on the particular food product and desired environment to control the passage of oxygen, moisture, etc. to and from the food product.

According to an exemplary embodiment, in order to produce microwaveable product 10, container 18 is first provided with susceptor 20 either as an integral part or separately bonded or inserted within container 18. Food product 12 is then introduced into the interior of container 18. In one embodiment, raw dough component 22 is first introduced into container 18 (e.g., in a round or other shape). Raw dough component 22 may be introduced into container 18 in a cooled state (e.g., at a temperature of less than forty degrees Fahrenheit, at ambient temperature, frozen, etc.). According to one embodiment, a manual or automated press mechanism (e.g., a pressing tool having a shape complimentary to the corrugated construction of the container/susceptor) may be used to press raw dough component 22 into container 18 such that raw dough component 22 substantially conforms to the construction of susceptor 20 and/or container 18. Pressing the raw dough into the corrugations ensures intimate contact between the dough and the susceptor material, and in conjunction with the rigidity of the container wall, provides an optimal support feature for the development and baking of the raw dough product. Pressing of the raw dough product is facilitated by the incline, or slope, of sidewall 34.

After introducing raw dough component 22, frozen, fully cooked component 24 may be introduced into container 18. In some embodiments, component 24 may be raw and/or a refrigerated component. After introducing component 24, cooked or uncooked, frozen component 26 may be introduced into container 18. Upon components 22, 24, 26 being introduced into container 18, cover 16 may be coupled to container 18. Further processing, packaging, etc., may be required after securing cover 16 to container 18, after which product 10 may be provided to retail stores and offered for sale to consumers in a frozen state. It should be understood that while food product 12 is described herein as being made up of three distinct component parts 22, 24, 26, food product 12 may comprise more or fewer discrete components of the same or different types and be introduced into container 18 in more or fewer steps than as described herein.

When a consumer wishes to bake (e.g., cook, heat, etc.) microwaveable product 10, the consumer may place product 10 (in a frozen state e.g., from a freezer, in a refrigerated state, in a non-refrigerated and non-frozen (e.g., ambient) state, etc.) within a microwave oven (e.g., a 1000 Watt microwave oven) and bake product 10 for an appropriate time period (e.g., for a period of about 2 minutes and 15 seconds, although baking times may vary between microwave ovens and food product/package types). According to an exemplary embodiment, preparation instructions (e.g., top removal instructions, baking time, etc.) for consumers may be provided on cover 16 and/or container 18. Upon food product 12 being fully baked, the consumer may remove cover 16, and consume food product 12 directly from container 18. Alternatively, the consumer may remove food product 12 from container 18 and place food product 12 on a separate dish (e.g., a plate, cup, bowl, etc.). According to yet another embodiment, one or more utensils (e.g., a spoon, fork, knife, or a combination thereof) may be provided with or integrated into a part of microwaveable product 10 (e.g., a spoon may be removably secured to or formed (e.g., molded, etc.) with container 18 or cover 16, etc.) to provide an all-in-one, on-the-go product for the consumer.

While susceptor 20 and container 18 are shown herein as having sidewalls with corrugated constructions, it should be understood that the corrugations may also be provided on the bottom portions of one or both of susceptor 20 and container 18. Furthermore, while susceptor 20 and container 18 are shown herein as being generally shaped as cups (e.g., similar to a traditional muffin cup), various shapes and sizes may be utilized for susceptor 20 and/or container 18 according to various alternative exemplary embodiments. According to an exemplary embodiment, container 18 may have a height of approximately 2.0 inches, a diameter across the top of about 3.5 inches, and a diameter across the bottom of about 2.5 inches. The dimensions of container 18 may vary according to other embodiments.

It is important to note that microwaveable product 10 shown in FIGS. 1-3 provides many advantages over more conventional microwaveable products. For example, microwaveable product 10 provides a complete meal (e.g., an individual breakfast entrée) that may be fully baked from the frozen state in less than 3 minutes (e.g., about 2 minutes and 15 seconds) using an easy-opening, easy-handling, portion controlled, portable container that may be held in a hand such that food product may be consumed directly out of the container.

Furthermore, container 18 lined with susceptor 20 provides optimized heating/baking due to the corrugated/fluted structure of susceptor 20, which, in combination with food product 12 conforming to the corrugated construction of container 18 and/or susceptor 20, increases the amount of heat delivered to food product 12 (relative to non-corrugated configurations) due to the increased surface area and the heat concentrations at the folds, or pleats, between corrugations, which increase delivery of heat to food product 12. Further, the corrugated construction permits moisture released as steam from food product 12 to escape (e.g., though cover 16) and prevents reabsorbtion of moisture which can lead to a soggy, oversaturated, undesirable food product. Moisture release may be further facilitated by the “slope” of sidewalls 34, 44 from bottom to top (e.g., whereby the diameter of the container increases from bottom to top). Such a configuration may promote “wicking” of moisture that is released from the interior of a food product (e.g., to facilitate movement of moisture from below the top portion of container 18 to the top portion of container 18, so that the moisture may escape container 18).

Further yet, the corrugated construction of susceptor 20 and container 18 provides a corresponding corrugated texture to the finished food product, which consumers may find more desirable than an otherwise smooth, rounded surface to the food product. Additionally, the rigidity and slope of container 18 facilitate the deposition and forming of food product 12 (in particular, raw dough component 22, prior to the addition of the remaining components) prior to baking. Also, susceptor 20 provides a browned or crisped surface for the areas of food product 12 in contact with susceptor 20.

Providing a susceptor such as susceptor 20 as an integral part of container 18 also serves to reduce the number of components in the microwaveable product (e.g., by eliminating a separate susceptor component), thereby potentially reducing materials costs for the microwave packaging, reducing assembly costs for the microwaveable product, and providing the user with a single-piece container rather than a container and separate susceptor. Furthermore, container 18 may rest directly on a microwave surface without the need for additional support structures to provide clearance, etc.

The various advantages and features discussed above with respect to FIGS. 1-3 are further applicable to a wide variety of variations with respect to the configuration of the microwaveable products disclosed herein. For example, FIGS. 4-6 illustrate alternative exemplary embodiments of microwaveable products that exhibit many of the features and advantages already discussed herein.

Referring to FIG. 4, a microwaveable product 110 is shown according to an exemplary embodiment, and includes a food product (not shown) and a package 114. Package 114 is similar to package 14 discussed with respect to FIGS. 1-3 and may include a cover 116, a container 118, and a susceptor 120 provided within or as part of container 118. Additionally, a rigid cover 150 may be provided in addition to cover 116 such that product 110 includes both a rigid and a flexible (e.g., “tear-away”) cover. Cover 150 may be configured such that cover 150 is easily removable by a user (e.g., a “pop-top” configuration), and may include a variety of features intended to facilitate the securing/removal of cover 150 to/from container 118. Providing a rigid polymer cover such as cover 150 may increase the durability of product 110. Cover 150 may be a rigid, polymer, vented cover or lid that facilitates heat transfer to the food product, and optimizes baking time and moisture exhaust. Cover 150 may be provided with one or more apertures 152 such that in one embodiment, product 110 may be heated after removing covers 116 and 150 and then replacing only cover 150. Alternatively, a portion of cover 116 may be “torn-away” and moisture may be vented through covers 116 and 150. As shown in FIG. 4, container 118 may have a generally flat exterior surface. According to an alternative embodiment, the exterior of container 118 may be corrugated or fluted in a similar fashion to container 18. Similarly, the interior of container 118 may be provided with a corrugated or fluted surface, and susceptor 120 may be provided as separate from or integral to container 118 and may have a corrugated or fluted construction.

Referring to FIG. 5, a microwaveable product 210 is shown according to an exemplary embodiment, and may include a food product 212, a container 218, a susceptor 220. However, rather than a flexible cover such as cover 16 shown in FIGS. 1-3, product 210 may be provided with a rigid cover 250 similar to cover 150 shown in FIG. 4. Cover 250 may be provided with apertures (not shown) to facilitate moisture release. Susceptor 220 may be provided as separate from or integral to container 218 and container 218 and/or susceptor 220 may have a corrugated construction.

Referring to FIG. 6, a microwaveable product 310 is shown according to another exemplary embodiment. As shown in FIG. 6, microwaveable product 310 may include a container 318, a food product 312, a flexible cover portion or lid 316 (e.g., a peelable and/or sealable material such as a film material, etc.), and a rigid or semi-rigid cover 350 (e.g., a polymer or flexible polymer cover, etc.). One or more components of microwave product 310 may be similar to corresponding components shown in one or more of FIGS. 1-5.

According to an exemplary embodiment, container 318 may have a fluted or corrugated construction that includes a number of wave-like flutes or corrugations 346 (e.g., waves, scallops, or similar corrugations or other features). According to one embodiment, container 318 may have approximately 15 corrugations 346 extending about the perimeter of container 318. According to another embodiment, the pitch of corrugations 346 may vary, and more or less corrugations 346 may be provided (e.g., 10, 20, 30, 35, etc.). Corrugations 346 may have a depth of approximately 0.14 inches, although according to various alternative embodiments, the corrugations may have other depths (e.g., more or less than 0.14 inches, such as 0.06 inches, 0.20 inches, etc.).

According to one embodiment, container 318 may include a sidewall 334 that extends between a bottom 332 and a lip portion 344. Container 318 may further include a susceptor inner portion or layer 320. Bottom 332 and sidewall 334 may be formed from a generally flat portion of paper material (e.g., a paper pulp material that may be provided in a generally circular shape), for example, via a thermoforming process where a paper material is formed around a mold portion to form the paper material into the shape of container 318. In some embodiments, susceptor 320 may be bonded or otherwise coupled or laminated to a paper material prior to forming container 318, such that sidewalls 334 and susceptor 320 are formed simultaneously during a process such as thermoforming. According to one embodiment, a paper material having a material thickness of approximately 0.025 inches (e.g., between 0.015 and 0.050 inches, between 0.020 and 0.030 inches, etc.) may be used to form sidewalls 334 and bottom 332.

In one embodiment, after forming sidewall 334 and bottom 332 from a paper material, lip portion 344 (e.g., flange, rim, etc.) may be formed through an injection-molding process to form a polymer lip portion that extends about the perimeter of the paper material forming sidewall 334 and bottom 332. According to an exemplary embodiment, lip portion 344 may be made from a polypropylene material, but may be made from various other materials according to various other exemplary embodiments. Sidewall 334 may further be “sloped” from bottom to top, as discussed in greater detail with respect to FIGS. 1-3.

Various modifications of the components of the microwaveable products shown according to the various exemplary embodiments may be made. For example, a susceptor having a corrugated construction may be provided separate from a corresponding container and/or cover according to an exemplary embodiment (e.g., a six ounce container and a corresponding perforated polymer cover). According to exemplary embodiments, food products may be provided having textured exterior surfaces resulting from the construction and use of a corrugated susceptor/container. According to any of these embodiments or other embodiments disclosed herein, the container, cover, susceptor and other components of the microwaveable product may be provided as either rigid or flexible components to suit a particular application. Furthermore, while the microwaveable package is shown having a generally circular cross-section, other shapes and configurations, such as square, rectangular, etc., may be used,

It should be noted that the various features of the microwaveable products disclosed herein may be used in a wide variety of applications, alone, or in combination. For example, one or more features of microwaveable product 10 discussed with respect to FIGS. 1-3 may be used in conjunction with or instead of one or more features of microwaveable product 110 discussed with respect to FIG. 4 and/or microwaveable products 210, 310 discussed with respect to FIGS. 5-6. All such combinations of features are intended to be within the scope of the present disclosure.

### Additional Embodiments

Referring generally to FIGS. 7-14, various exemplary embodiments of a microwaveable product are shown. Generally, FIGS. 7-14 illustrate microwaveable products that include a container, a core, and one or more lids, or covers. The container, core, and lids may define separate compartments (e.g., first and second compartments, volumes, enclosed areas, etc.) that may be separately sealed from each other (e.g., such that dry or liquid food products or mixtures provided in one compartment cannot travel to another compartment or escape to the environment, etc.). The embodiments discussed with respect to FIGS. 7-14 may include one or more features discussed with respect to FIGS. 1-6, and all such combinations of features should be understood to be within the scope of the present application.

Referring to FIGS. 7-10, a microwaveable product 410 is shown according to an exemplary embodiment. Product 410 includes a container 418 (e.g., cup, bowl, etc.), a seal 414 (e.g., a first cover, seal or foil, a flexible lid, etc.), a cover 416 (e.g., a second cover or lid, semi-rigid cover, etc.), a core 422 (e.g., a column, protrusion, divider, etc.), and a food product 412. Food product 412 may be sealed within container 418 using one or both of seal 414 and cover 416.

Food product 412 may be any suitable type of food product (e.g., a dry powder, mix, etc.), including frozen, refrigerated, or non-refrigerated, non-frozen food products such as a dry mixture (e.g., dry dough product, dry mix or powder, dried fruit, such as cherries, raisins, etc., yogurt chips, dried grains, etc.). Food product 412 may further include any of the food products discussed with respect to the various other embodiments disclosed herein.

Container 418 (e.g., cup, etc.) may include a base 428 and a sidewall 430 that extends upward from base 428. Base 428 and/or sidewall 430 may have a corrugated, or fluted, construction, as described with respect to the various embodiments disclosed herein. Furthermore, at least a portion of one or both of base 428 and sidewall 430 may include a susceptor material 420 (e.g., a microwaveably activated material such as a metal layering of aluminum, etc.). First compartment 424 and second compartment 426 generally conform to the shapes of container 418 and core 422. For example, according to one embodiment, first compartment 424 has a generally annular shape, and second compartment 426 is provided to the interior of compartment 424 and has a generally cylindrical shape.

Core 422 (e.g., tube, column, protrusion, cylinder, etc.) may be provided within container 418 and be a generally columnar member that extends upward from base 428 of container 430. In some embodiments, core 422 may be provided as a separate member that may be bonded or otherwise coupled or secured to base 428. In other embodiments, core 422 may be formed as an integral part of container 418 (e.g., via an injection molding process, etc.). In further embodiments, core 422 may be configured to be separated from base 428 prior to and/or after baking food product 412 (e.g., so that core 422 may then be easily removed from an inner portion of food product 412). Further yet, core 422 may have a base that is separate from base 428 of container 430, and may be “snapped” or otherwise attached to base 428. According to one embodiment, core 422 may include a susceptor material (e.g., a microwaveably-activated material such as a metal layering, etc.) provided on all or a portion of core 422.

According to an exemplary embodiment, as shown in FIG. 10, core 422 may have a generally cylindrical shape, and a circular cross-section that remains substantially constant along the height of core 422. In another embodiment, as shown in FIGS. 7-8, core 422 may have a cross-section that increases from base 428 toward the top of container 430. In yet other embodiments, core 422 may have a cross-section that decreases from base 428 toward the top of container 430. Further, while core 422 is shown as having a generally circular cross-section, it should be understood that according to various other embodiments, core 422 may have other cross-sectional configurations (e.g., square, rectangular, triangular, oval, odd-shaped, etc.).

Seal 414 may be a flexible foil or other suitable material. In some embodiments, seal 414 may be induction sealed to container 418 and/or cover 416 at an edge portion 436 so as to create a tamper-resistant package for food product 412. In further embodiments, seal 414 may be induction or otherwise sealed to core 422 to separately seal first compartment 424 (e.g., the space or volume defined by sidewall 430, base 428, core 422, and seal 414 (or alternatively, cover 416 should seal 414 be removed)) and second compartment 426 (e.g., the space or volume defined by core 422, base 428 and seal 414 (or alternatively, cover 416). Seal 414 may be peelably removeable from container 418 (e.g., via a tab extending beyond edge portion 436) to expose food product 412 within container 418 (e.g., so that a liquid such as water, milk, etc. may be added to a dry food mix or powder within first compartment 424, etc.). Food product 412 may be provided in one or both of compartments 424, 426. For example, first compartment 424 may include a dry mixture such as a dough or batter, and second compartment 426 may include a different type of food product such as a topping, frosting, icing, syrup, various food particles (dried fruits, proteins, etc.), and so on. Further a portion of food product 412 (e.g., a syrup) may require separate packaging.

Cover 416 may be a flexible cover made from a polymer or other material. As shown in FIGS. 7-8, cover 416 may be coupled to container 418 (e.g., with seal 414 disposed between cover 416 and core 422). According to an exemplary embodiment, cover 416 may include a lip, or flange feature 438, that provides a “snap fit” (e.g., a “leak-proof” fit that does not permit passage of liquids, solids, etc.) between cover 416 and container 418. In other embodiments, cover 416 may be coupled to container 418 using any suitable manner. Cover 416 may include one or more vents or apertures to provide venting for food product 412.

As shown in FIGS. 7-10, cover 416 may include a depressable portion 432 (e.g., a moveable portion, a raised/recessed portion, an inner portion, a pop-top, a detent/indent, etc.) and a flexible portion 434 (e.g., an expandable portion, a bendable portion, etc.). Referring to FIG. 8, upon a user removing cover 416 and seal 414, the user may replace cover 416 by coupling cover 416 to container 418 at edge portion 436 via lip 438. Further, a user may then depress (e.g., via a finger, etc.) depressable portion 432 such that depressable portion 432 is received within and secured to core 422. For example, depressable portion 432 may be formed with a convex portion 440 that is configured to be pressed over a corresponding detent (e.g., bump, ridge, etc.) provided on core 422. Alternatively, portion 440 may be received within a corresponding recess (e.g., a concave portion, etc.) provided in core 422. Other means of securing cover 416 to core 422 may be used according to various other embodiments (e.g., an interference fit, corresponding indents/detents, projections/recesses, etc.). The interfaces of cover 416 with container 418 and core 422 are intended to provide separate compartments 424, 426 (e.g., by forming a first seal between cover 416 and container 418, and a second seal between cover 416 and core 422). Compartments 424, 426 may be sealed from the environment and from each other so as to prevent the release of any food products such as dry mixes, liquids, etc. that may be sealed within one or both compartments.

According to an exemplary embodiment, in order to facilitate movement of depressable portion 432, flexible portion 434 (e.g., an expandable portion, a pliable portion, etc.) may be provided as part of cover 416. In one embodiment, flexible portion 434 may include one or more generally concentric features such as ridges, waves, convex/concave portions etc., extending circumferentially about all or a portion of cover 416 and that permit depressable portion 432 to be deflected relative to a normal, non-deflected position. For example, as shown in FIG. 7, depressable portion 432 is separated from core 422 in a non-depressed position. After being depressed, or deflected, depressable portion 432 may be positioned below the uppermost portion of core 422, as shown in FIG. 8. The amount of deflection permitted by depressable portion 432 and flexible portion 434 may be modified to suit any particular embodiment (e.g., to require more or less pressure to depress/deflect depressable portion 432, to limit the amount of deflection, etc.).

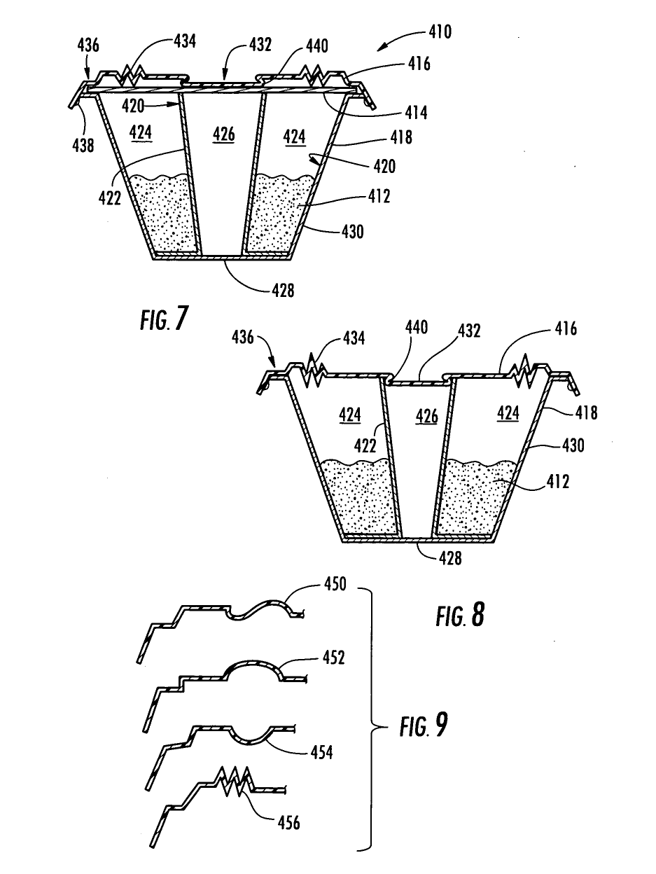

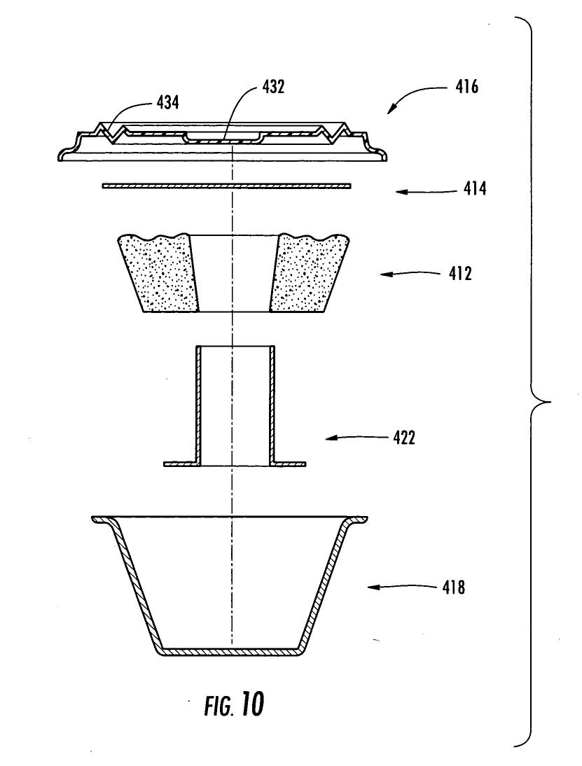

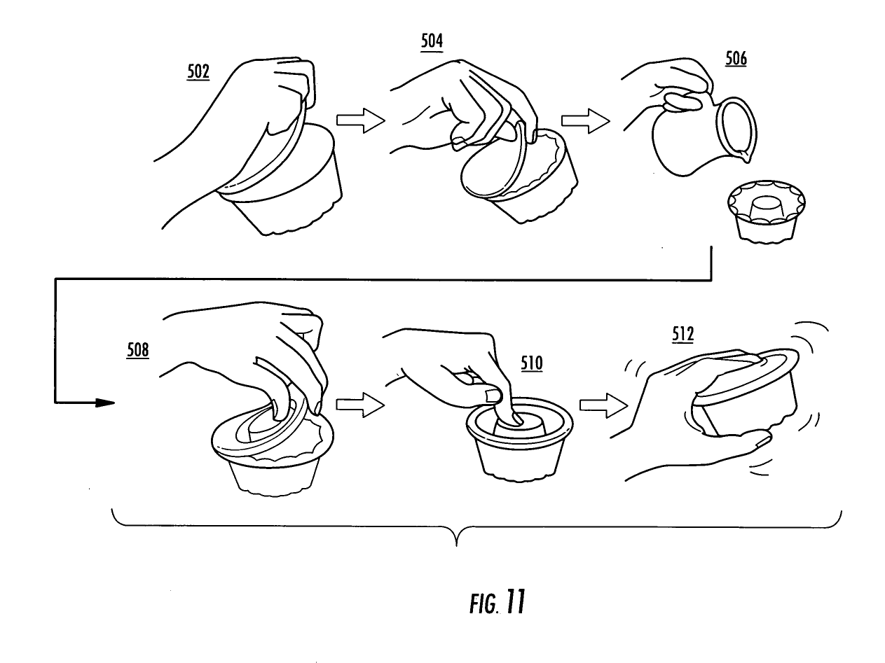

Referring to FIG. 9, as discussed above, flexible portion 434 may take a variety of shapes, configurations, etc. For example, flexible portion 434 may include one or more wavey-shaped features 450, one or more convex/concave features 452, 454, one or more zig-zagged features 456, sinusoidal features, etc. Further, while in some embodiments, flexible portion 434 may extend about depressable portion 432 in a generally continuous, concentric manner, in various alternative embodiments, flexible portion 434 may be provided in a discontinuous and/or non-circular/non-concentric manner (e.g., with flexible portion 434 provided intermittently about cover 416). Further still, other shapes and sizes of shapes may be utilized for flexible portion 434 than those illustrated herein.

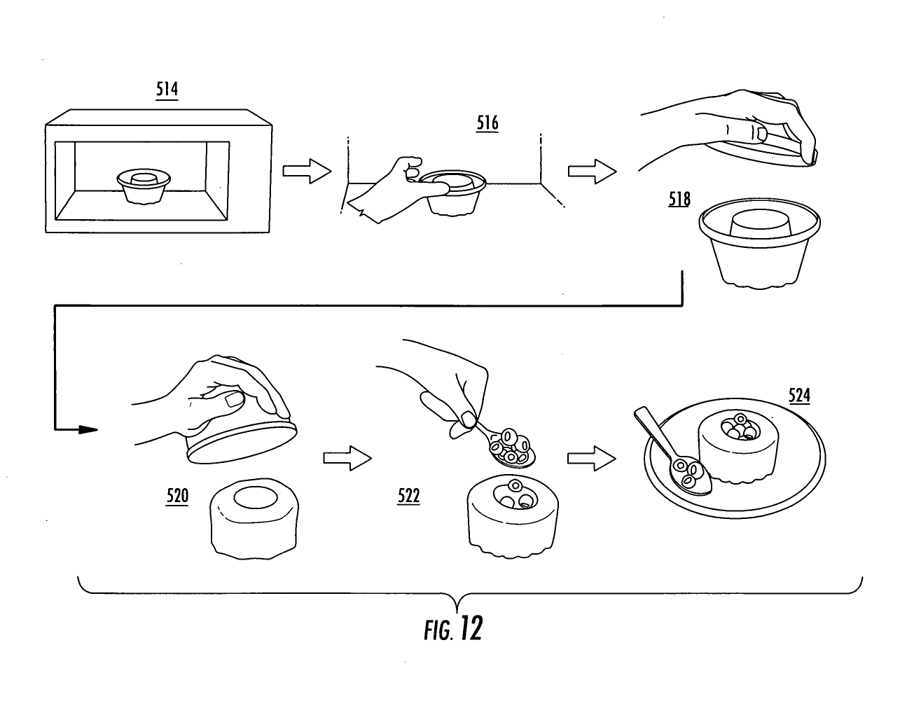

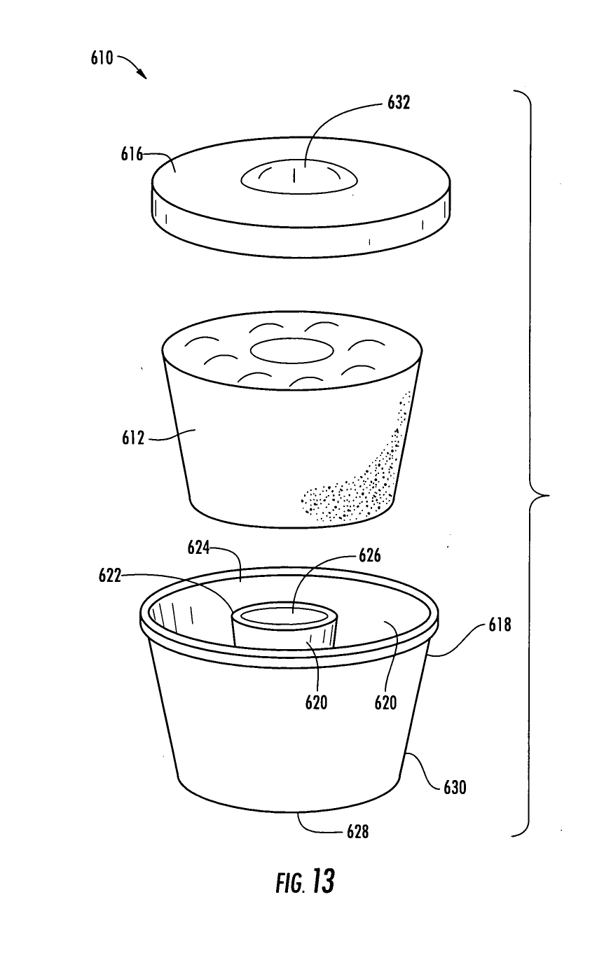

Referring now to FIGS. 11-12, a process of utilizing a microwaveable product such as product 410 is shown according to an exemplary embodiment. First the cover (e.g., cover 416) is removed from the container (e.g., container 416) (step 502). Next, the seal (e.g., seal 414) is removed from the container (step 504), exposing a food product (e.g., food product 412) within the container. A core (e.g., core 422) may be provided within the container to form first and second separate compartments. After removing the cover and seal, a liquid may be added to the food product to form a mixture (e.g., a batter or dough intended to be microwaveably baked) (step 506). The cover may then be replaced (step 508) and a portion of the cover (e.g., depressable portion 432) depressed to couple the cover to both the container and the core, sealing the mixture within the container. Next, a user may agitate the mixture (step 512) by shaking, etc., and place the microwaveable product within a microwave (step 514) for baking. Upon being microwaveably baked, a user may remove the baked food product from the microwave oven (step 516) and remove the cover, thereby exposing the baked food product (step 518). In order to remove the baked food product from the container, a user may flip the container over (e.g., 180 degrees) so that the baked food product slides out of the container and away from the core (step 520). In this way, a recess may be provided in the food product where the core had been positioned. Should a user wish, one or more additional food products (e.g., toppings, fillings, etc.) may be placed within the recess (step 522) before or while the user consumes the food product (step 524). It should be noted that FIGS. 11-12 are provided for purposes of illustration, and the various steps noted therein may be modified, rearranged, omitted, repeated, etc.

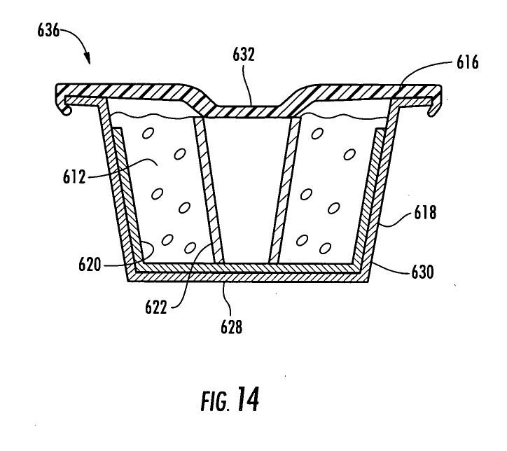

Referring now to FIGS. 13-14, a microwaveable product 610 is shown according to an exemplary embodiment, and includes a container 618, a core 622, a food product 612, and a cover, or lid, 616. Product 610 may further include a seal (not shown) similar to seal 414 discussed with respect to FIGS. 7-10.

As shown in FIG. 13, cover 616 may include a raised portion 632. According to an exemplary embodiment, raised portion 632 serves a similar purpose as depressable portion 432 discussed with respect to FIGS. 7-10. For example, raised portion 632 may initially (e.g., during shipment, merchandising, etc. of product 612) be provided in a raised position, as shown in FIG. 13. Upon a user exposing food product 612 (and, optionally, adding a liquid such as water, milk, etc.), cover 616 may be placed back onto container 618 and raised portion 632 depressed so as to couple to core 622, as shown in FIG. 14.

Referring further to FIG. 14, one or both of container 618 and core 622 may include a susceptor material 620 that covers or is otherwise bonded to or integrated into at least a portion of container 618 and/or core 622. Susceptor material 620 may be provided, for example, on a portion of a sidewall 630 of container 618 extending upward from base 628 (e.g., susceptor 620 may be provided up to a distance of approximately 80 percent of the height of sidewall 630).

Product 610 may otherwise be similar to product 410 discussed herein. For example, cover 616 may further include flexible portions (not shown) to facilitate depression of raised portion 632. Sidewall 630, base 628, and/or core 622 may have a fluted or corrugated construction. Further, one or more vents or apertures may be provided in cover 616 to permit moisture to escape from the interior of container 618. Further yet, product 610 may be utilized in a similar manner to that discussed with respect to FIGS. 11-12.

It is important to note that the terms “container,” “package,” “susceptor,” and “food product” are intended to be broad terms and not terms of limitation. These terms may be used with any of a variety of products or arrangements and are not intended to be limited to use with particular applications.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Such joining may also relate to a mechanical or fluid relationship between the two components.

It is also important to note that the construction and arrangement of the elements of the microwaveable product as shown in the exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. Accordingly, all such modifications are intended to be included within the scope of the present disclosure as defined in the appended claims. The order or sequence of any process or method steps may be varied or re-sequenced according to alternative embodiments. Other substitutions, modifications, changes and/or omissions may be made in the design, operating conditions and arrangement of the exemplary embodiments without departing from the spirit of the present disclosure.

What is claimed is:

1. A microwaveable product comprising:
a container having a base and at least one sidewall extending from the base, the base and the at least one sidewall defining an interior;
a core extending from the base within the interior, the core and the container defining a first compartment and a second compartment; and
a lid having a moveable portion being moveable to selectively engage the core and to separately seal the first compartment from the second compartment.

2. The product of claim 1, wherein the at least one sidewall includes a susceptor material.

3. The product of claim 1, wherein the at least one sidewall includes a plurality of flutes extending about the perimeter of the container.

4. The product of claim 1, wherein the core includes a susceptor material.

5. The product of claim 4, wherein the susceptor material faces the first compartment.

6. The product of claim 1, wherein the core has a circular cross-section that decreases from the base toward the lid.

7. The product of claim 1, wherein the moveable portion of the lid engages an inner portion of the core.

8. The product of claim 1, wherein the lid includes a flexible region extending about the moveable portion, the flexible region permitting the moveable portion of the lid to more relative to the remainder of the lid.

9. The product of claim 8, wherein the flexible region includes a plurality of ridges provided generally concentrically about the moveable portion in an accordion-like manner.

10. The product of claim 1, further comprising a removeable seal provided between the lid and the container

11. The product of claim 1, wherein the first compartment is defined by the base, the first sidewall, and the core, and wherein the second compartment is defined by the base and the core.

12. The product of claim 10, wherein at least one of the first compartment and the second compartment is configured to receive a food product.

13. A method of using a microwaveable product comprising:
providing a microwaveable product having a container, a core disposed within the container, a first cover, and a second cover disposed between the first cover and the container, wherein the container and the core define first and second compartments;
removing the first cover;
removing the second cover; and
coupling the first cover to the container and the core and depressing a portion of the first cover to seal the first and second compartments.

14. The method of claim 13, further comprising:
providing a food product within the first compartment prior to removing the second cover;
adding a liquid to the first compartment after removing the second cover;
agitating the food product and liquid within the first compartment to form a mixture after coupling the first cover to the container and the core and depressing a portion of the first cover; and
microwaveably heating the mixture to form a baked food product.

15. The method of claim 13, wherein the core is configured to permit the baked food product to be slidably removed from the container.

16. A microwaveable product comprising:
a container having a base and at least one sidewall extending from the base, the base and the at least one sidewall defining an interior, at least a portion of the at least one sidewall including a susceptor material;
a core extending from the base within the interior, at least a portion of the core including a susceptor material;
a cover configured to be coupled to the container; and
a flexible seal provided between the cover and the core and removeably sealed to the container.

17. The product of claim 16, wherein the at least one sidewall includes a plurality of flutes.

18. The product of claim 16, wherein at least one of the cover and the flexible seal is induction sealed to the container.

19. The product of claim 16, wherein the cover includes a depressable portion configured to sealably engage the core to define first and second compartments after removal of the flexible seal, the depressable portion sealing the first compartment from the second compartment.

20. The product of claim 19, wherein the cover includes an expandable region surrounding the depressable portion, the expandable region permitting the depressable portion to engage the core after removal of the flexible seal.

21. The product of claim 19, wherein the first compartment substantially surrounds the second compartment.

22. The product of claim 21, wherein the first compartment is annularly shaped.

23. The product of claim 19, further comprising a food product provided within at least one of the first and second compartments.
